(19) United States
(12) Patent Application Publication
(10) Pub. No.: US 2025/0225203 A1
(43) Pub. Date: Jul. 10, 2025

(54) SAMPLE SIZE ESTIMATION DEVICE, SAMPLE SIZE ESTIMATION METHOD, AND SAMPLE SIZE ESTIMATION PROGRAM

(71) Applicant: NIPPON TELEGRAPH AND TELEPHONE CORPORATION, Tokyo (JP)

(72) Inventors: Yasunori AKAGI, Musashino-shi (JP); Naoki MARUMO, Musashino-shi (JP); Hideaki KIN, Musashino-shi (JP); Taichi ASAMI, Musashino-shi (JP)

(73) Assignee: NIPPON TELEGRAPH AND TELEPHONE CORPORATION, Tokyo (JP)

(21) Appl. No.: 18/848,924

(22) PCT Filed: Apr. 5, 2022
(86) PCT No.: PCT/JP2022/017107

§ 371 Date: Sep. 20, 2024

(51) Int. Cl. G06F 17/18; G06F 17/11; G06F 17/17

(52) U.S. Cl. CPC G06F 17/18; G06F 17/11; G06F 17/17

(57) ABSTRACT

A sample size estimation device includes an input unit, a cost function approximation unit, a network construction unit, a minimum convex cost flow problem solving unit, an estimation control unit, and an output unit. The network construction unit creates an instance of a minimum convex cost flow problem from a linearly approximated objective function approximated by the cost function approximation unit. The minimum convex cost flow problem solving unit obtains an optimum solution of the instance of the minimum convex cost flow problem. The estimation control unit controls and executes a whole MAP estimation by issuing a command while exchanging data with the cost function approximation unit, the network construction unit, and the minimum convex cost flow problem solving unit. The estimation control unit also obtains a MAP estimation solution from the optimum solution of the instance. The output unit outputs the obtained MAP estimation solution.

### TECHNICAL FIELD

The present invention relates to a sample size estimation device, a sample size estimation method, and a sample size estimation program.

### BACKGROUND ART

With the development of sensors and information and communication technology, various types of data are being collected on a large scale. However, due to privacy considerations and the difficulty of observation, in many cases, only aggregated data is available, rather than data of individuals. For example, human location information obtained from GPS or the like is sometimes provided as hourly area population data that cannot be traced to individuals due to privacy considerations. Here, the hourly area population data is information on the number of people in each area at each time step. A Collective Graphical Model (CGM) (Non Patent Literature 3) is a model that allows deeper information to be extracted from data by performing interpolation, estimation, and learning based on probabilistic modeling even in situations where only aggregated data is available in this way, and is widely used.

One operation in the Collective Graphical Model (CGM) is to perform MAP (maximum a posteriori) estimation on a true contingency table of a graphical model when the observed aggregate data and the potential of the underlying graphical model are given. Since this MAP estimation is essential for interpolation and estimation, and is a very important operation that is also used as a learning subroutine, various studies have been conducted thereon.

These will be described using mathematical formulas. First, CGM will be briefly described.

Assuming that H=(N, A) is an undirected graph, a graphical model expressed by the following probability mass function is considered.

$$\begin{matrix}[ Math . 1 ] & \\ p ( x ) = Pr ( X = x ) & ( 1 )\end{matrix}$$

$$= \frac{1}{Z} {\prod }_{( i , j ) ∈ A} {ϕ}_{ij} ( {x}_{i} , {x}_{j} ) \qquad ( 2 )$$

Here, φᵢⱼ (xᵢ, xⱼ) is a local potential defined for the variable (Xᵢ, Xⱼ), and Z (θ) is a normalization constant (distribution function). Further, it is assumed that the random variable Xᵢ takes values in a finite set Xᵢ.

It is assumed that the samples from this graphical model are x⁽¹⁾, . . . , x^{(M)}. A contingency table nᵢ=(nᵢ(xᵢ)|xᵢ∈Xᵢ) for vertices and a contingency table nᵢⱼ=(nᵢⱼ(xᵢ, xⱼ) |xᵢ∈Xᵢ, xⱼ∈Xⱼ) for sides are defined as follows.

$$\begin{matrix}[ Math . 2 ] & \\ {n}_{i} ( {x}_{i} ) = {\sum }_{m = 1}^{M} 𝕀 ( {X}_{i}^{( m )} = {x}_{i} ) . & ( 3 )\end{matrix}$$

$${n}_{ij} ( {x}_{i} \text{?} {x}_{j} ) = {\sum }_{m = 1}^{M} 𝕀 ( {X}_{i}^{( m )} = {x}_{i} \text{?} {X}_{j}^{( m )} = {x}_{j} ) \qquad ( 4 )$$

$$\text{?} \text{indicates text missing or illegible when filed}$$

Here, [symbol] (⋅) is an indicator function.

In this case, the distribution of n (this is called a CGM distribution) can be written as follows. Here, vᵢ is the degree of vertex i.

$$\begin{matrix}[ Math . 3 ] & \\ p ( n ) = M ! \text{?} \frac{{\prod }_{i ∈ N} {\prod }_{{x}_{i} ∈ {𝒳}_{i}} {( {n}_{i} ( {x}_{i} ) ! )}^{{v}_{i} - 1}}{{\prod }_{( i \text{?} j ) ∈ A} {\prod }_{{x}_{i} ∈ {𝒳}_{i} \text{?} {x}_{j} ∈ {𝒳}_{j}} {n}_{ij} ( {x}_{i} \text{?} {x}_{j} )} \text{?} g ( n ) \text{?} 𝕀 ( n ∈ {𝕃}_{M}^{ℤ} ) & ( 5 )\end{matrix}$$

$$g ( n ) = \frac{1}{{Z}^{M}} {\prod }_{( i \text{?} j ) ∈ A} {\prod }_{{x}_{i} \text{?} {x}_{j}} \text{?} {( {x}_{i} \text{?} {x}_{j} )}^{{n}_{ij} ( {x}_{i} \text{?} {x}_{j} )} \qquad ( 6 )$$

$${𝕃}_{M}^{ℤ} = \{ n ∈ {ℤ}_{\geq 0}^{\vert n \vert} \vert M = {\sum }_{{x}_{i}} {n}_{i} ( {x}_{i} ) ∀ i ∈ N \text{?} {n}_{i} ( {x}_{i} ) = {\sum }_{{x}_{j}} {n}_{i j} ( {x}_{i} \text{?} {x}_{j} ) ∀ i ∈ N \text{?} {x}_{i} ∈ {𝒳}_{i} \text{?} j ∈ N ( i ) \} \qquad ( 7 )$$

$$\text{?} \text{indicates text missing or illegible when filed}$$

Further, it is assumed that the observed value y is generated from some probability distribution p(y|n) representing observation noise. Specifically, the value nᵢ is observed at each vertex according to the following observation noise model.

$$\begin{matrix}[ Math . 4 ] & \\ {p}_{node} ( y \vert n ) = {\prod }_{i ∈ N , {x}_{\text{?}}} {p}_{i , {x}_{i}} ( {y}_{i} ( {x}_{i} ) \vert {n}_{i} ( {x}_{i} ) ) & ( 8 )\end{matrix}$$

$$\text{?} \text{indicates text missing or illegible when filed}$$

Here, it is assumed that −log pᵢ, xᵢ (yᵢ(xᵢ)|nᵢ(xᵢ)) is a convex function with respect to nᵢ(xᵢ). The posterior distribution of n is given by p(n|y)∝p(n)·p(y|n). Then, the MAP estimation problem is expressed as maxₙ p(n|y). For simplicity, it is assumed that Xᵢ={1, 2, . . . , R} for any i=1, 2, . . . , |N|. The discussion below can be easily extended to other cases.

In the present invention, the case where graph H is a path graph is considered. A path graph is an undirected graph whose vertex set is V=[T] and whose side set is E={(t, t+1)|t∈[T−1]}. Here, for a natural number n, [n] :={1, 2, . . . , n}. The MAP estimation problem on the path graph is modified. Considering this as a minimization problem of −log p(n|y), the following optimization problem will be solved.

$$\begin{matrix}[ Math . 5 ] & \\ {min}_{n} {\sum }_{t = 1}^{T - 1} {\sum }_{i , j ∈ [ R ]} {f}_{tij} ( {n}_{tij} ) + {\sum }_{t = 2}^{T - 1} {\sum }_{i ∈ [ R ]} g ( {n}_{ti} ) + {\sum }_{t = 1}^{T} {\sum }_{i ∈ [ R ]} {h}_{ti} ( {n}_{ti} ) . & ( 9 )\end{matrix}$$

$$s . t . {\sum }_{i ∈ [ R ]} {n}_{ti} = M ( t ∈ [ T ] ) \text{?} {\sum }_{j ∈ [ R ]} {n}_{tij} = {n}_{t i} ( t ∈ [ T - 1 ] \text{?} i ∈ [ R ] ) .$$

$${\sum }_{i ∈ [ R ]} {n}_{tij} = {n}_{t + 1 , j} ( t ∈ [ T - 1 ] \text{?} j ∈ [ R ] ) \text{?} {n}_{tij} \text{?} {n}_{ti} ∈ {ℤ}_{\geq 0} .$$

$$\text{?} \text{indicates text missing or illegible when filed}$$

Here, fₜᵢⱼ(z) :=log z!−z·log φₜᵢⱼ, g(z) :=−log z!, hₜᵢ(z) :=−log pₜᵢ(yₜᵢ|z), and ntxᵢ :=nt(xᵢ), nₜᵢⱼ :=nt, t+1(xᵢ, xⱼ), φₜᵢⱼ :=φt, t+1 (xᵢ, xⱼ).

The MAP estimation problem (9) is generally shown to be NP-hard, and therefore it is very difficult to solve it efficiently. Therefore, methods have been proposed, such as a method that continuously relaxes the problem using Stirling's approximation and solves it by message passing (Non Patent Literature 4), and a method that solves the problem by applying a discrete DC (difference of convex) algorithm (Non Patent Literature 1).

### CITATION LIST

### Non Patent Literature

[Non Patent Literature 1] Yasunori Akagi, Naoki Marumo, Hideaki Kim, Takeshi Kurashima, and Hiroyuki Toda. Non-approximate inference for collective graphical models on path graphs via discrete difference of convex algorithm. In NeurIPS, 2021.

[Non Patent Literature 2] Takanori Maehara and Kazuo Murota. A framework of discrete DC programming by discrete convex analysis. Mathematical Programming, 152(1-2):435-466, 2015.

[Non Patent Literature 3] Daniel R. Sheldon and Thomas G. Dietterich. Collective graphical models. In NIPS, pages 1161-1169, 2011.

[Non Patent Literature 4] Tao Sun, Daniel Sheldon, and Akshat Kumar. Message passing for collective graphical models. In ICML, pages 853-861, 2015.

### SUMMARY OF INVENTION

### Technical Problem

In the related art, a sample size M is assumed to be given in advance. However, in actual applications, M is rarely given in advance, and it is necessary to also estimate the sample size M by some means. However, no means for estimating the sample size M has been provided so far.

An object of the present invention is to provide a sample size estimation device, a sample size estimation method, and a sample size estimation program that can appropriately estimate a sample size M from observation.

### Solution to Problem

An aspect of the present invention is a sample size estimation device. The sample size estimation device includes an input unit, a cost function approximation unit, a network construction unit, a minimum convex cost flow problem solving unit, an estimation control unit, and an output unit. Potential information of a graphical model on a path graph and observed aggregate data are input to the input unit. The cost function approximation unit linearly approximates a concave function part of an objective function of a MAP estimation problem including a sample size from the potential information of the graphical model and the aggregate data input to the input unit. The network construction unit creates an instance of a minimum convex cost flow problem from the objective function linearly approximated by the cost function approximation unit. The minimum convex cost flow problem solving unit obtains an optimum solution of the instance of the minimum convex cost flow problem created by the network construction unit. The estimation control unit controls and executes the whole MAP estimation by issuing a command while exchanging data with the cost function approximation unit, the network construction unit, and the minimum convex cost flow problem solving unit, and finally obtains a MAP estimation solution from the optimum solution of the instance of the minimum convex cost flow problem obtained by the minimum convex cost flow problem solving unit. The output unit outputs the obtained MAP estimation solution.

An aspect of the present invention is a sample size estimation method. The sample size estimation method includes: inputting potential information of a graphical model on a path graph and observed aggregate data; linearly approximating a concave function part of an objective function of a MAP estimation problem including a sample size from the input potential information of the graphical model and the input aggregate data; creating an instance of a minimum convex cost flow problem from the linearly approximated objective function; obtaining an optimum solution of the created instance of the minimum convex cost flow problem; and obtaining a MAP estimation solution from the obtained optimum solution of the instance of the minimum convex cost flow problem.

An aspect of the present invention is a sample size estimation program. The sample size estimation program causes a computer to execute the functions of each component of the sample size estimation device described above.

### Advantageous Effects of Invention

According to the present invention, there are provided a sample size estimation device, a sample size estimation method, and a sample size estimation program that can appropriately estimate a sample size M from observation.

### BRIEF DESCRIPTION OF DRAWINGS

FIG. 1 is a block diagram illustrating an example of a functional configuration of a sample size estimation device according to an embodiment.

FIG. 2 is a block diagram illustrating an example of a hardware configuration of the sample size estimation device according to the embodiment.

FIG. 3 is a flowchart illustrating sample size estimation executed by the sample size estimation device according to the embodiment.

FIG. 4 is a diagram illustrating an example of formulation to a minimum cost flow problem in the embodiment.

### DESCRIPTION OF EMBODIMENTS

Hereinafter, an embodiment of the present invention will be described with reference to the drawings.

### (Functional Configuration)

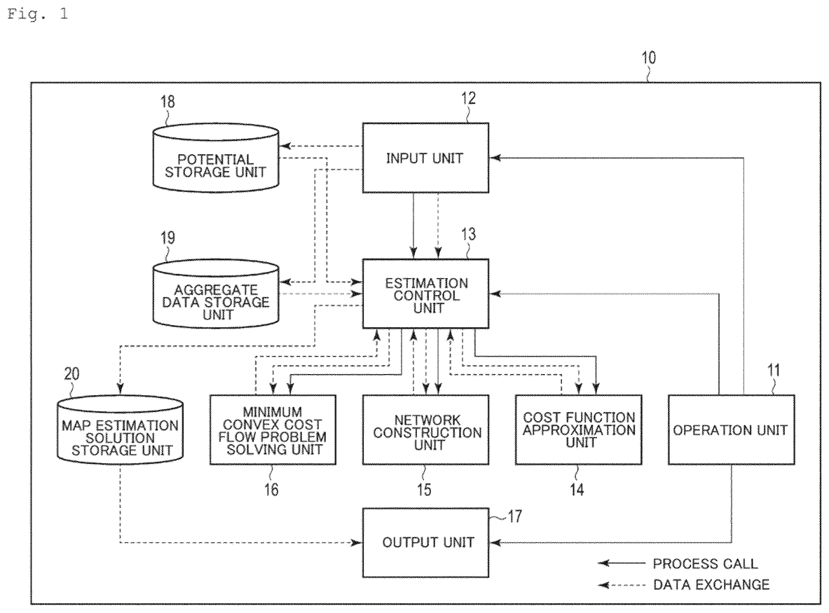

First, a functional configuration of a sample size estimation device according to the embodiment will be described. FIG. 1 is a block diagram illustrating an example of the functional configuration of the sample size estimation device 10 according to the embodiment. The sample size estimation device 10 estimates a sample size M at the same time as outputting a MAP estimation solution of a Collective Graphical Model (CGM) on a path graph. In other words, the sample size estimation device 10 outputs a MAP estimation solution including the sample size M.

The sample size estimation device 10 includes an operation unit 11, an input unit 12, an estimation control unit 13, a cost function approximation unit 14, a network construction unit 15, a minimum convex cost flow problem solving unit 16, an output unit 17, a potential storage unit 18, an aggregate data storage unit 19, and a MAP estimation solution storage unit 20.

The operation unit 11 is an interface for performing operations from the outside. The operation unit 11 enables operations such as inputting data, storing and correcting input data by operating the input unit 12, starting MAP estimation by issuing a command to the estimation control unit 13, and outputting MAP estimation results by issuing a command to the output unit 17. The input data is potential information of the graphical model and observed aggregate data.

Data is input to the input unit 12 from the outside. The input unit 12 stores data in the potential storage unit 18 and the aggregate data storage unit 19 and corrects the data.

The estimation control unit 13 controls and executes the whole MAP estimation by issuing commands while exchanging data with the cost function approximation unit 14, the network construction unit 15, and the minimum convex cost flow problem solving unit 16, and finally obtains a MAP estimation solution.

The cost function approximation unit 14 linearly approximates the concave function part of the objective function.

The network construction unit 15 creates an instance of the minimum convex cost flow problem.

The minimum convex cost flow problem solving unit 16 obtains an optimum solution of the instance of the minimum convex cost flow problem created by the network construction unit 15.

The output unit 17 reads the MAP estimation solution stored in the MAP estimation solution storage unit 20 and outputs it.

The potential storage unit 18 stores potential information of the graphical model input to the input unit 12.

The aggregate data storage unit 19 stores the aggregate data input to the input unit 12.

The MAP estimation solution storage unit 20 stores the MAP estimation solutions obtained by the estimation control unit 13, the cost function approximation unit 14, the network Construction unit 15, and the minimum convex cost flow problem solving unit 16.

### (Hardware Configuration)

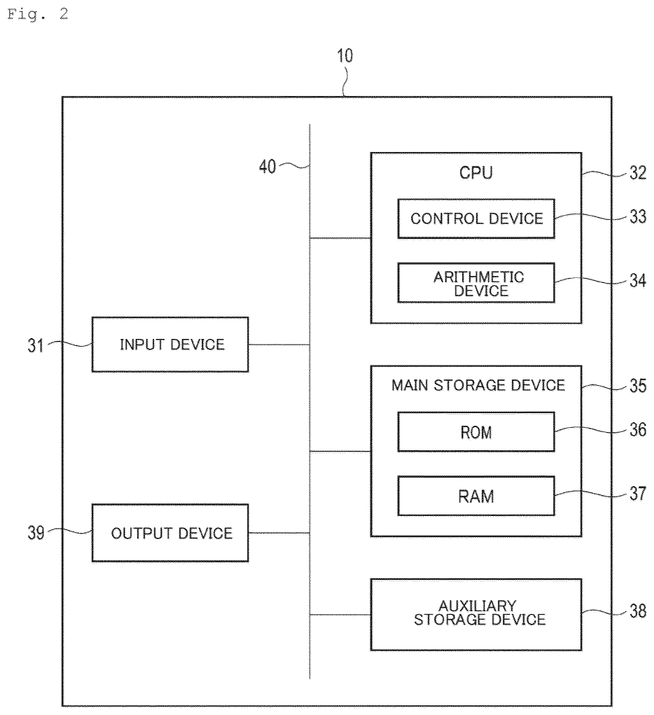

Next, a hardware configuration of the sample size estimation device 10 will be described with reference to FIG. 2. The sample size estimation device 10 includes a computer. For example, the sample size estimation device 10 includes a personal computer, a server computer, or the like. FIG. 2 is a block diagram illustrating an example of the hardware configuration of the sample size estimation device 10 according to the embodiment.

As illustrated in FIG. 2, the sample size estimation device 10 includes an input device 31, a CPU 32, a main storage device 35, an auxiliary storage device 38, and an output device 39. The sample size estimation device 10 may further include other peripheral devices in addition to these.

The input device 31, the CPU 32, the main storage device 35, the auxiliary storage device 38, and the output device 39 are electrically connected to each other through a bus 40, and perform exchange of data and commands through the bus 40.

The input device 31 is a device that receives a signal from the outside, converts the signal into data, and passes the data to the CPU 32, the main storage device 35, and the auxiliary storage device 38.

The output device 39 is a device that receives data from the CPU 32, the main storage device 35, and the auxiliary storage device 38, converts the data into a signal, and outputs the signal.

The main storage device 35 stores programs and data necessary for processing executed by the CPU 32. The CPU 32 performs various types of processing by reading and executing necessary programs and data from the main storage device 35.

The main storage device 35 includes a non-rewritable ROM (Read Only Memory) 36 and a rewritable RAM (Random Access Memory) 37. The RAM 37 and the auxiliary storage device 38 exchange programs and data with each other.

The ROM 36 is a non-volatile memory and stores a program (BIOS) that controls the CPU 32 at startup.

The RAM 37 is a volatile memory and temporarily stores programs and data necessary for processing by the CPU 32.

The auxiliary storage device 38 stores programs and data supplied through an external device or a network, and provides the RAM 37 with programs and data temporarily necessary for the processing of the CPU 32. For example, the auxiliary storage device 38 is a non-volatile memory such as an HDD (Hard Disk Drive), an SSD (solid state drive), or the like.

The CPU 32 is a processor and is hardware that processes data and commands. The CPU 32 includes a control device 33 that issues commands, and an arithmetic device 34 that processes data.

The control device 33 controls the input device 31, the arithmetic device 34, the main storage device 35, the auxiliary storage device 38, and the output device 39.

The arithmetic device 34 reads programs and data from the RAM 37, executes the programs to process the data, and provides the processed data to the RAM 37.

In such a hardware configuration, the input device 31 constitutes the operation unit 11. The output device 39 constitutes the output unit 17. The main storage device 35 and the auxiliary storage device 38 constitute the potential storage unit 18, the aggregate data storage unit 19, and the MAP estimation solution storage unit 20. The CPU 32 and the main storage device 35 constitute the input unit 12, the estimation control unit 13, the cost function approximation unit 14, the network construction unit 15, and the minimum convex cost flow problem solving unit 16.

For example, the CPU 32 loads a program for executing the functions of the estimation control unit 13, the cost function approximation unit 14, the network construction unit 15, and the minimum convex cost flow problem solving unit 16 from the auxiliary storage device 38 to the RAM 37, and executes the loaded program to operate the estimation control unit 13, the cost function approximation unit 14, the network construction unit 15, and the minimum convex cost flow problem solving unit 16.

### Processing of Sample Size Estimation

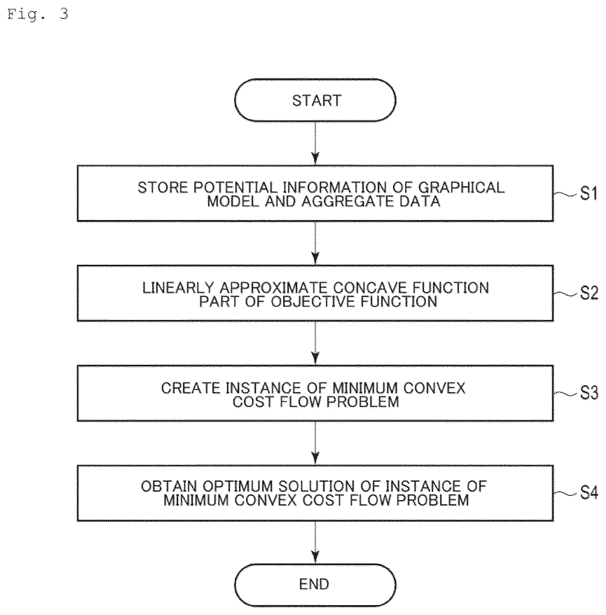

Next, the processing of sample size estimation executed by the sample size estimation device 10 will be described. FIG. 3 is a flowchart illustrating an example of a processing procedure and processing content of sample size estimation executed by the sample size estimation device according to the embodiment.

In step S1, potential information of the graphical model and aggregate data are stored. Specifically, in response to a command from the operation unit 11, the input unit 12 receives potential information of the graphical model and aggregate data from the outside, corrects the potential information and aggregate data if necessary, stores the potential information in the potential storage unit 18, and stores the aggregate data in the aggregate data storage unit 19.

In step S2, the concave function part of the objective function is linearly approximated. More specifically, in response to a command to start estimation from the operation unit 11, the estimation control unit 13 outputs a command to linearly approximate the concave function part of the objective function to the cost function approximation unit 14. In accordance with this, the estimation control unit 13 reads potential information from the potential storage unit 18, reads aggregate data from the aggregate data storage unit 19, and passes the potential information and the aggregate data to the cost function approximation unit 14. The cost function approximation unit 14 linearly approximates the potential information and the aggregate data, and returns the linearly approximated potential information and aggregate data to the estimation control unit 13.

In steps S1 and S2, the input unit 12 may receive a command for receiving potential information of the graphical model and aggregate data and a command for starting estimation from the operation unit 11, and pass the command for starting estimation, the potential information, and the aggregate data to the estimation control unit 13.

In step S3, an instance of the minimum convex cost flow problem is created. More specifically, the estimation control unit 13 issues a command to create an instance of the minimum convex cost flow problem to the network construction unit 15. In accordance with this, the estimation control unit 13 passes the potential information and aggregate data linearly approximated by the cost function approximation unit 14 to the network construction unit 15. The network construction unit 15 creates an instance of the minimum convex cost flow problem from the received potential information and aggregate data, and returns the created instance of the minimum convex cost flow problem to the estimation control unit 13.

In step S4, an optimum solution of the instance of the minimum convex cost flow problem is obtained. More specifically, the estimation control unit 13 outputs a command for obtaining the optimum solution of the instance of the minimum convex cost flow problem to the minimum convex cost flow problem solving unit 16. In accordance with this, the estimation control unit 13 passes the instance of the minimum convex cost flow problem created by the network construction unit 15 to the minimum convex cost flow problem solving unit 16. The minimum convex cost flow problem solving unit 16 obtains an optimum solution of the received instance of the minimum convex cost flow problem and returns the obtained optimum solution of the instance of the minimum convex cost flow problem to the estimation control unit 13. The estimation control unit 13 obtains a MAP estimation solution including the received optimum solution sample size M of the instance of the minimum convex cost flow problem, and stores the obtained MAP estimation solution in the MAP estimation solution storage unit 20.

Thereafter, in response to a command from the operation unit 11, the output unit 17 reads the MAP estimation solution of the MAP estimation problem including the sample size M from the MAP estimation solution storage unit 20 and outputs the read MAP estimation solution to the outside.

The estimation of the sample size M executed by the sample size estimation device 10 will be described in detail below. The sample size estimation device 10 estimates the sample size M by performing MAP estimation simultaneously with a contingency table n.

### (MAP Estimation Problem)

In order to perform MAP estimation of the sample size M, a prior distribution p(M) is also set for the sample size M. Here, it is assumed that −log p(M) is a convex function. As p(M), uniform distribution (10), Poisson distribution (11), Gaussian distribution (12), and the like can be used.

$$\begin{matrix}[ Math . 6 ] & \\ {p}_{uniform} ( M ) = \{ \begin{matrix}\frac{1}{{M}_{max}} & M ∈ \{ 0 \text{?} 1 \text{?} … {M}_{max} \} \\ 0 & otherwise\end{matrix} & ( 10 )\end{matrix}$$

$${p}_{Poisson} ( M ) = \{ \begin{matrix}\frac{{λ}^{M} exp ( - λ )}{M !} & M ∈ {ℤ}_{\geq 0} \\ 0 & otherwise\end{matrix} \qquad ( 11 )$$

$${p}_{P o i s s o n} ( M ) ∝ \{ \begin{matrix}exp ( - \frac{{( M - μ )}^{2}}{2 {σ}^{2}} ) & M ∈ {ℤ}_{\geq 0} \\ 0 & otherwise\end{matrix} \qquad ( 12 )$$

$$\text{?} \text{indicates text missing or illegible when filed}$$

In this case, the probability distribution p(n, M|y) is as follows.

$$\begin{matrix}[ Math . 7 ] & \\ p ( n \text{?} M \vert y ) = \frac{p ( n , M \text{?} y )}{p ( y )} & ( 13 )\end{matrix}$$

$$∝ p ( n \text{?} M \text{?} y ) \qquad ( 14 )$$

$$= p ( M ) \text{?} p ( n \vert M ) \text{?} p ( y \vert n ) \qquad ( 15 )$$

$$\text{?} \text{indicates text missing or illegible when filed}$$

Since the MAP estimation problem is min_{n,M}−log p(n, M|y), by rearranging the equations, the MAP estimation problem including M becomes as follows, similarly to (9).

$$\begin{matrix}[ Math . 8 ] & \\ {min}_{n , M} {\sum }_{t = 1}^{T - 1} {\sum }_{i , j ∈ [ R ]} {f}_{tij} ( {n}_{tij} ) + {\sum }_{t = 2}^{T - 1} {\sum }_{i ∈ [ R ]} g ( {n}_{ti} ) + {\sum }_{t = 1}^{T} {\sum }_{i ∈ [ R ]} {h}_{t i} ( {n}_{ti} ) + {k}_{1} ( M ) + {k}_{2} ( M ) . & ( 16 )\end{matrix}$$

$$s . t . {\sum }_{i ∈ [ R ]} {n}_{ti} = M ( t ∈ [ T ] ) \text{?} {\sum }_{j ∈ [ R ]} {n}_{tij} = {n}_{ti} ( t ∈ [ T - 1 ] \text{?} i ∈ [ R ] ) ,$$

$${\sum }_{i ∈ [ R ]} {n}_{tij} = {n}_{t + 1 \text{?} j} ( t ∈ [ T - 1 ] \text{?} j ∈ [ R ] ) \text{?} {n}_{tij} \text{?} {n}_{ti} \text{?} M ∈ {ℤ}_{\geq 0} .$$

$$\text{?} \text{indicates text missing or illegible when filed}$$

Here, k₁(M) :=−log p(M)+M log Z, K₂(M) :=−log M!. The value of log Z can be calculated by dynamic programming.

### (Solution Method for MAP Estimation Problem)

Similarly to Non Patent Literature 1, the above optimization problem is solved by the discrete DC algorithm (Non Patent Literature 2) and the minimum convex cost flow algorithm.

### (Application of DC Algorithm)

Here, the linear approximation of the concave function part of the objective function executed by the cost function approximation unit 14 will be described. The linear approximation of the concave function part of the objective function is performed by applying the DC algorithm.

The DC algorithm is a framework for solving optimization problems of the form minneD P(n)=Q(n)+R(n), where Q(n) is a convex function and R(n) is a concave function. The DC algorithm performs optimization by generating a sequence of feasible solutions n⁽¹⁾, . . . , n^{(s)} that satisfy P(n(1))≥P(n (2))≥ . . . P(n(s))).

$$\begin{matrix}[ Math . 9 ] & \\ \text{?} & \end{matrix}$$

$$\text{?} \text{indicates text missing or illegible when filed}$$

When n⁽¹⁾, . . . , n^{(s)} has already been calculated, the function R̅^{(s)}(n) that satisfies the following three conditions is calculated.
1. R̅^{(s)}(n^{(s)})=R(n^{(s)})
2. R̅^{(s)}(n)≥R(n) (∀n∈D)
3. P̅^{(s)}(n) := Q(n)+R̅^{(s)}(n) can be efficiently optimized on D

Since R(n) is concave function, conditions 1 and 2 are satisfied by setting R̅^{(s)}(n)=R(n^{(s)})+V̅R(n^{(s)})·(n−n^{(s)}) (a linear approximation of R(n) in n^{(s)}). Using this function, a new feasible solution is obtained by n^{(s+1)}=arg minₙ P̅^{(s)}(n). This can be easily done by condition 3. In this case, since P(n^{(s+1)})≤P̅^{(s)}(n^{(s+1)}≤P̅^{(s)}(n^{(s)})=P(n^{(s)}) issatisfied, P(n⁽¹⁾)≥P(n⁽²⁾)≥ . . . ≥P(n^{(s)})≥P(n^{(s+1)}) is obtained.

$$\begin{matrix}[ Math . 10 ] & \\ \text{?} & \end{matrix}$$

$$\text{?} \text{indicates text missing or illegible when filed}$$

In order to apply the DC algorithm, the object function needs to be expressed as a sum of a convex function and a concave function. Here, when the function f : [symbol] _{≥0}→ [symbol] ∪{+∞} satisfies f(z+2)+f(z)≥2·f(z+1) for all z∈ [symbol] _{≥0}, f is said to be a discrete convex function. Also, when −f is the discrete convex function, f is said to be a discrete concave function. In this case, it is confirmed that functions fₜᵢⱼ, hₜᵢ, and k₁ are discrete concave functions and functions g and k₂ are discrete concave functions. Therefore, the DC algorithm is clearly applicable by setting Q(n, M)=Σₜ₌₁^{T-1}Σ_{i,j∈[R]}fₜᵢⱼ(nₜᵢⱼ)+Σₜ₌₁^{T}Σ_{i∈[R]}hₜⱼ(nₜᵢ)+k₁(M) and R(n,M)=Σₜ₌₂^{T-1}Σ_{i∈[R]}g(nₜᵢ)+k₂(M). In this case, the functions are functions on a discrete set, it is called a discrete DC algorithm.

$$\text{?} \qquad [ Math . 11 ]$$

$$\text{?} \text{indicates text missing or illegible when filed}$$

Here, it is set that αₜᵢ^{(s)} is a real number that satisfies −log (nₜᵢ^{(s)}+1)≤αₜᵢ^{(s)}≤ −log nₜᵢ^{(s)}, g̅ₜᵢ^{(s)}(z) := −log (nₜᵢ^{(s)}!)+αₜᵢ⁽⁾·(z−nₜᵢ^{(s)}). Also, it is set that β^{(s)} is a real number that satisfies −log (M^{(s)}+1)≤β^{(s)}). In this case, the function R̅^{(s)} (n M) :=Σₜ₌₁^{T-1}Σ_{i,j∈[R]}g̅ₜᵢ^{(s)} (nₜᵢ)+k̅₂^{(s)}(M) satisifes R̅^{(s)} (n^{(s)}, M^{(s)})=R(n^{(s)}, M^{(s)})and R̅^{(s)} (n, M)≥R (n, M).

$$\text{?} \qquad [ Math . 12 ]$$

$$\text{?} \text{indicates text missing or illegible when filed}$$

### (Efficient Minimization of P̅^{(s)}(n, M))

Next, a method for efficiently minimizing P̅^{(s)} (n, M) will be described. For preparation to this, first, the minimum cost flow problem will be described. The (nonlinear) minimum cost flow problem is the following problem. A directed graph G=(V, E) is given as an input, and a cost function cᵢⱼ : [symbol] _{≥0}→ [symbol] ∪{+∞} is assigned to each side (i, j)∈E. Furthermore, a demand bᵢ∈Z is given to each vertex i∈V. The minimum cost flow problem is a problem of finding the flow with the minimum cost that satisfies the capacity constraints of each side and the demand constraints of each vertex. If the flow on the side (i, j)∈E is xᵢⱼ, this problem can be formulated as follows.

$$\begin{matrix}[ Math . 13 ] & \\ {min}_{x ∈ {Z}^{[ E ]}} \text{?} {\sum }_{( i , j ) ∈ E} {c}_{i j} ( {x}_{ij} ) \text{?} & ( 17 )\end{matrix}$$

$$s . t . {\sum }_{j : ( i , j ) ∈ E} {x}_{i j} - {\sum }_{j : ( j , i ) ∈ E} {x}_{j i} = {b}_{i} ∀ i ∈ V .$$

$$\text{?} \text{indicates text missing or illegible when filed}$$

In particular, when the cost functions cᵢⱼ are all discrete convex functions, this problem is called a minimum convex cost flow problem, and it is known that an efficient algorithm exists.

[symbol] [Math. 14]

Then, the minimization problem of P̅^{(s)}(n, M) can be reduced to this minimum convex cost flow problem. The method will be described below. A minimum cost cost flow problem on the graph g=(ν, ε) is created using the following procedures.
The vertex set ν is defined as ν :={o,d}∪(U_{t∈[T]}(Uₜ∪Wₜ). Here, Uₜ :=(u_{t,i})_{i∈[R]}, Wₜ :=(w_{t,i})_{i∈[R]}.
The side set consists of five types of sides less than or equal to ε. Here, (u, v, c (z)) represents the side of the cost function c (z) from vertex u to vertex v.
For i∈[R], seides (o, u_{1,i}, 0) and (w_{T,i}, d, 0)
For t=1, T and i∈[R], side (u_{t,i}, w_{t,i}, hₜᵢ(z))
For t=2, . . . , T−1, and i∈ [R], side (u_{t,i}, w_{t,i}, g̅ₜᵢ^{(s)} (z)+hₜᵢ(z))
For t∈[T−1] and i, j∈[R], side (w_{t,i}, u_{t+1,i}, fₜᵢⱼ(z))
side (d, o, k1(z)+k̅₂^{(s)}(z))
For v∈ν, bᵥ=0

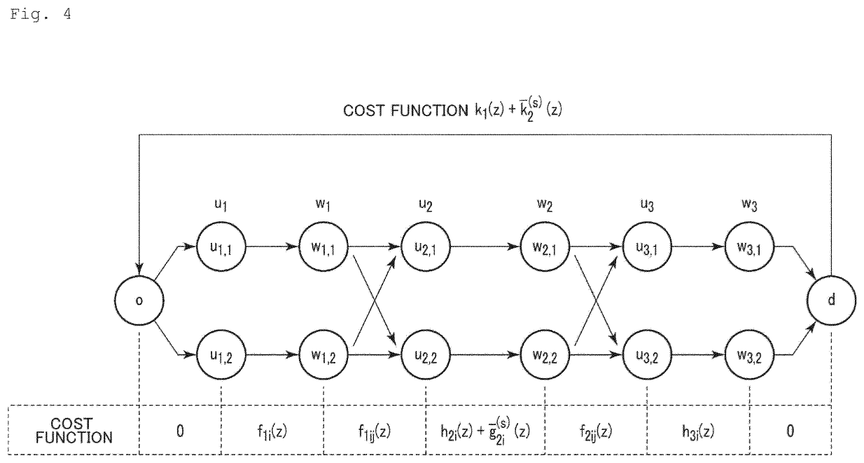

FIG. 4 illustrates an instance of the minimum cost flow problem constructed when |T|=3 and R=2.

Since all the cost functions on the sides of the minimum cost flow problem constructed above satisfy discrete convexity, this problem is a minimum convex cost flow problem. It is known that algorithms such as the shortest path iteration method and the capacity scaling method exist for the minimum convex cost flow problem, and can efficiently obtain the optimum solution.

$$\begin{matrix}[ Math . 15 ] & \\ \text{?} & \end{matrix}$$

$$\text{?} \text{indicates text missing or illegible when filed}$$

From the optimum solution z* of the minimum cost flow problem constructed above, an optimization problem min_{n,M} P̅^{(s)}(n, M) is constructed as follows.

$$\begin{matrix}[ Math . 16 ] & \\ {\text{?}}_{\text{?}}^{*} := {\text{?}}_{\text{?}}^{*} \text{?} & ( 18 )\end{matrix}$$

$${\text{?}}_{tij}^{*} := {\text{?}}_{\text{?}}^{*} \text{?} \qquad ( 19 )$$

$${M}^{*} := {\text{?}}_{d , o}^{*} \text{?} \qquad ( 20 )$$

$$\text{?} \text{indicates text missing or illegible when filed}$$

$$\begin{matrix}[ Math . 17 ] & \\ \text{?} & \end{matrix}$$

$$\text{?} \text{indicates text missing or illegible when filed}$$

In this case, n*, M* are the optimum solutions of the problem min_{n,M} P̅^{(s)}(n, M).

### (Overall Picture of Algorithm)

To summarize the above, the overall picture of the algorithm is as follows.

Math. 18
Algorithm 1DCA for problem (16)

| | |
|---|---|
| 1: | n⁽¹⁾ ← 0, M ← 0 |
| 2: | for s = 1, 2, ... do |
| 3: | n^{(s+1)}, M^{(s+1)} |
| 4: | if P(n^{(s)}, M^{(s)}) = P(n^{(s+1)}, M^{(s+1)}) then |
| 5: | return n^{(s)}, M^{(s)} |
| 6: | end if |
| 7: | end for |

Line 3 is n*, M* obtained by solving the minimum convex cost flow problem constructed by the procedure described above (Efficient Minimization of P̅^{(s)}(n, M)).

In this algorithm, it is guaranteed that the objective function value is monotonically decreasing and that the algorithm stops after a finite number of iterations.

### Effects

According to the embodiment, it becomes possible to appropriately estimate the sample size M from observation.

Note that the present invention is not limited to the embodiments described above and can variously be modified at an execution stage within a scope not departing from the gist of the present invention. In addition, the embodiments may be combined as appropriate, and in such a case, combined effects can be achieved. In addition, the embodiments described above include various aspects of the invention, and the various aspects of the invention can be extracted by combinations selected from a plurality of disclosed constituent elements. For example, even when some of all the constituent elements disclosed in the embodiments are deleted, as long as the problems can be solved and the effects can be obtained, a configuration from which the constituent elements are deleted can be extracted as an aspect of the invention.

### REFERENCE SIGNS LIST

10 . . . Sample size estimation device
11 . . . Operation unit
12 . . . Input unit
13 . . . Estimation control unit
14 . . . Cost function approximation unit
15 . . . Network construction unit
16 . . . Minimum convex cost flow problem solving unit
17 . . . Output unit
18 . . . Potential storage unit
19 . . . Aggregate data storage unit
20 . . . MAP estimation solution storage unit
31 . . . Input device
32 . . . CPU
33 . . . Control device
34 . . . Arithmetic device
35 . . . Main storage device
36 . . . ROM
37 . . . RAM
38 . . . Auxiliary storage device
39 . . . Output device
40 . . . Bus

1. A sample size estimation device, comprising:
a processor configured to:
allow potential information of a graphical model on a path graph and observed aggregate data are to be input;
linearly approximate a concave function part of an objective function of a MAP estimation problem including a sample size from the input potential information of the graphical model and the input aggregate data;
create an instance of a minimum convex cost flow problem from the linearly approximate objective function;
obtain an optimum solution of the created instance of the minimum convex cost flow problem;
control and execute the whole MAP estimation and obtain a MAP estimation solution from the obtained optimum solution of the instance of the minimum convex cost flow problem; and
output the obtained MAP estimation solution.

2. The sample size estimation device according to claim 1, wherein a prior distribution p (M), which is a uniform distribution, is set for a sample size M, where −log p(M) is a convex function, and the MAP estimation problem including the sample size is expressed as follows:
$${min}_{n , M} {\sum }_{t = 1}^{T - 1} {\sum }_{i , j ∈ [ R ]} {f}_{lij} ( {n}_{tij} ) + {\sum }_{t = 2}^{T - 1} {\sum }_{i ∈ [ R ]} g ( {n}_{ti} ) + {\sum }_{t = 1}^{T} {\sum }_{i ∈ [ R ]} {h}_{ti} ( {n}_{ti} ) + {k}_{1} ( M ) + {k}_{2} ( M ) \text{?} \qquad [ Math . 1 ]$$
$$s . t . {\sum }_{i ∈ [ R ]} {n}_{ti} = M ( t ∈ [ T ] ) \text{?} {\sum }_{j ∈ [ R ]} {n}_{tij} = {n}_{ti} ( t ∈ [ T - 1 ] \text{?} i ∈ [ R ] ) \text{?}$$
$${\sum }_{i ∈ [ R ]} {n}_{tij} = {n}_{t + 1 , j} ( t ∈ [ T - 1 ] \text{?} j ∈ [ R ] ) \text{?} {n}_{tij} \text{?} {n}_{ti} \text{?} M ∈ {ℤ}_{\geq 0} .$$
$$\text{?} \text{indicates text missing or illegible when filed}$$

3. The sample size estimation device according to claim 1, wherein the processor performs linear approximation of the concave function part of the objective function by applying a DC algorithm.

4. The sample size estimation device according to claim 1, wherein the processor creates a minimum convex cost flow problem on a graph g=(ν, ε) using the following procedures:
$$The vertex set υ is defined as v := \{ o , d \} ⋃ ( {U}_{t ∈ [ T ]} ( {U}_{t} ⋃ {W}_{t} ) . \qquad [ Math . 2 ]$$
$$Here , {U}_{t} := {( {u}_{t , i} )}_{i ∈ [ R ]} , {W}_{t} := {( {w}_{t , i} )}_{i ∈ [ R ]} .$$
$$The side set consists of five types of sides less than or equal to ε .$$
$$Here , ( u , v , c ( z ) ) represents the side of the cost function c ( z ) from vertex$$
$$u to vertex v .$$
$$For i ∈ [ R ] , seides ( o , {u}_{1 , i} , 0 ) and ( {w}_{T , i} , d , 0 )$$
$$For t = 1 , T and i ∈ [ R ] , side ( {u}_{t , i} , {w}_{t , i} , {h}_{ti} ( z ) )$$
$$For t = 2 , … , T - 1 , and i ∈ [ R ] , side ( {u}_{t , i} , {w}_{t , i} , {\overline{g}}_{ti}^{( s )} ( z ) + {h}_{ti} ( z ) )$$
$$For t ∈ [ T - 1 ] and i , j ∈ [ R ] , side ( {w}_{t , i} , {u}_{t + 1 , i} , {f}_{tij} ( z ) )$$
$$side ( d , o , k 1 ( z ) + {\overline{k}}_{2}^{( s )} ( z ) )$$
$$For v ∈ υ , {b}_{v} = 0.$$

5. The sample size estimation device according to claim 1, further comprising a storage configured to:
store the input potential information of the graphical model;
store the input aggregate data; and
store the obtained MAP estimation solution, wherein
the processor stores the input potential information of the graphical model, and stores the input aggregate data in the storage,
the processor reads the potential information of the graphical model and the aggregate data from the storage, and stores the MAP estimation solution in the storage, and
the processor reads the MAP estimation solution from the storage and outputs the MAP estimation solution to the outside.

6. The sample size estimation device according to claim 1, wherein the processor corrects the input potential information of the graphical model and corrects the input aggregate data.

7. A sample size estimation method comprising:
inputting potential information of a graphical model on a path graph and observed aggregate data;
linearly approximating a concave function part of an objective function of a MAP estimation problem including a sample size from the input potential information of the graphical model and the input aggregate data;
creating an instance of a minimum convex cost flow problem from the linearly approximated objective function;
obtaining an optimum solution of the created instance of the minimum convex cost flow problem; and
obtaining a MAP estimation solution from the optimum solution of the instance of the minimum convex cost flow problem.

8. A storage medium storing a sample size estimation program that causes a computer to execute the functions of each component of the sample size estimation device according to claim 1.
